(19) United States
(12) Patent Application Publication
(10) Pub. No.: US 2020/0160199 A1
(43) Pub. Date: May 21, 2020

(54) MULTI-MODAL DIALOGUE AGENT

(71) Applicant: KONINKLIJKE PHILIPS N.V., EINDHOVEN (NL)

(72) Inventors: SHEIKH SADID AL HASAN, CAMBRIDGE, MA (US); OLADIMEJI FEYISETAN FARRI, YORKTOWN HEIGHTS, NY (US); AADITYA PRAKASH, WALTHAM, MA (US); VIVEK VARMA DATLA, CAMBRIDGE, MA (US); KATHY MI YOUNG LEE, WESTFORD, MA (US); ASHEQUL QADIR, MELROSE, MA (US); JUNYI LIU, WINDHAM, NH (US)

(21) Appl. No.: 16/630,196

(22) PCT Filed: Jul. 9, 2018
(86) PCT No.: PCT/EP2018/068461

§ 371 Date: Jan. 10, 2020

Related U.S. Application Data
(60) Provisional application No. 62/531,147, filed on Jul. 11, 2017.

(51) Int. Cl. G06N 5/04; G06N 5/02; G06N 20/00; G06F 16/9032; G06F 3/01; G06K 9/00

(52) U.S. Cl. CPC G06N 5/043; G06N 5/022; G06K 9/00302; G06F 16/90332; G06F 3/017; G06N 20/00

(57) ABSTRACT

Methods and systems for interacting with a user. Systems in accordance with various embodiments described herein provide a collection of models that are each trained to perform a specific function. These models may be categorized into static models that are trained on an existing corpus of information and dynamic models that are trained based on real-time interactions with users. Collectively, the models provide appropriate communications for a user.

### TECHNICAL FIELD

Embodiments described herein generally relate to systems and methods for interacting with a user and, more particularly but not exclusively, to systems and methods for interacting with a user that use both static and dynamic knowledge sources.

### BACKGROUND

Existing dialogue systems are mostly goal-driven or task-driven in that a conversational agent is designed to perform a particular task. These types of tasks may include customer service tasks, technical support tasks, or the like. Existing dialogue systems generally rely on tailored efforts to learn from a large amount of annotated, offline textual data. However, these tailored efforts can be extremely labor intensive. Moreover, these types of solutions typically learn from textual data and do not consider other input modalities for providing responses to a user.

Other existing dialogue systems include non-goal-driven conversational agents that do not focus on any concrete task. Instead, these non-goal-driven agents try to learn various conversational patterns from transcripts of human interactions. However, these existing solutions do not consider additional input modalities from different data sources.

A need exists, therefore, for methods and systems that interact with users that overcome these disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a system for interacting with a user. The system includes an interface for receiving input from a user; a static learning engine having a plurality of static learning modules, each module preconfigured using at least one static knowledge source, wherein the static learning engine executes the plurality of static learning modules for generating a communication to the user; a dynamic learning engine having a plurality of dynamic learning modules, each module trained substantially in real time from at least one of the user input and at least one dynamic knowledge source, wherein the dynamic learning engine executes the plurality of dynamic learning modules to assist in generating the communication to the user; and a reinforcement engine configured to analyze output from at least one of the plurality of static learning modules and the plurality of dynamic learning modules, and further configured to select an appropriate communication for the user based on the output from at least one of the plurality of static learning modules and the plurality of dynamic learning modules.

In some embodiments, the at least one static knowledge source includes a conversational database storing data regarding previous conversations between the system and the user.

In some embodiments, at least one of the static knowledge source and the dynamic knowledge source comprises text, image, audio, and video.

In some embodiments, the system further includes an avatar agent transmitting the selected communication to the user via the interface.

In some embodiments, the input from the user includes at least one of a verbal communication, a gesture, a facial expression, and a written message.

In some embodiments, the reinforcement engine associates the output from at least one of the plurality of static learning modules and the plurality of dynamic learning modules with a reward, and selects the appropriate communication based on the reward associated with a particular output.

In some embodiments, each of the plurality of static learning modules and the plurality of dynamic learning modules is configured to perform a specific task to assist in generating the communication to the user.

In some embodiments, the system further includes a plurality of dynamic learning modules and a plurality of static learning modules that together execute a federation of models that are each specially configured to perform a certain task to generate a response to the user.

In some embodiments, the system further includes a first agent and a second agent in a multi-agent framework, wherein each of the first agent and the second agent include a static learning and a dynamic learning engine and converse in an adversarial manner to generate one or more responses.

According to another aspect, embodiments relate to a method for interacting with a user. The method includes receiving input from a user via an interface; executing, via a static learning engine having a plurality of static learning modules, each module preconfigured using at least one static knowledge source, the plurality of static learning modules for generating a communication to the user; executing, via a dynamic learning engine having a plurality of dynamic learning modules, each module trained substantially in real time from at least one of the user input and at least one dynamic knowledge source, the plurality of dynamic learning modules to assist in generating the communication to the user; analyzing, via a reinforcement engine, output from at least one of the plurality of static learning modules and the plurality of dynamic learning modules; and selecting, via the reinforcement engine, an appropriate communication for the user based on the output from at least one of the plurality of static learning modules and the plurality of dynamic learning modules.

In some embodiments, the at least one static knowledge source includes a conversational database storing data regarding previous conversations between the system and the user.

In some embodiments, at least one of the static knowledge source and the dynamic knowledge source comprises text, image, audio, and video.

In some embodiments, the method further includes transmitting the selected communication to the user through the interface via an avatar agent.

In some embodiments, the input from the user includes at least one of a verbal communication, a gesture, a facial expression, and a written message.

In some embodiments, further comprising associating the output from at least one of the plurality of static learning modules and the plurality of dynamic learning modules with a reward using the reinforcement engine, and selecting the appropriate communication using the reinforcement engine based on the reward associated with a particular output.

In some embodiments, wherein each of the plurality of static learning modules and the plurality of dynamic learning modules is configured to perform a specific task to assist in generating the communication to the user.

According to yet another aspect, embodiments relate to a computer readable medium containing computer-executable instructions for interacting with a user. The medium includes computer-executable instructions for receiving input from a user via an interface; computer-executable instructions for executing, via a static learning engine having a plurality of static learning modules, each module preconfigured using at least one static knowledge source, the plurality of static learning modules for generating a communication to the user; computer-executable instructions for executing, via a dynamic learning engine having a plurality of dynamic learning modules, each module trained substantially in real time from at least one of the user input and at least one dynamic knowledge source, the plurality of dynamic learning modules to assist in generating the communication to the user; computer-executable instructions for analyzing, via a reinforcement engine, output from at least one of the plurality of static learning modules and the plurality of dynamic learning modules; and computer-executable instructions for selecting, via the reinforcement engine, an appropriate communication for the user based on the output from at least one of the plurality of static learning modules and the plurality of dynamic learning modules.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for interacting with a user in accordance with one embodiment;

FIG. 2 illustrates the static learning engine of FIG. 1 in accordance with one embodiment;

FIG. 3 illustrates the architecture of the question answering module of FIG. 2 in accordance with one embodiment;

FIG. 4 illustrates the architecture of the question generation module of FIG. 2 in accordance with one embodiment;

FIG. 5 illustrates the dynamic learning engine of FIG. 1 in accordance with one embodiment;

FIG. 6 illustrates the architecture of the user profile generation module of FIG. 5 in accordance with one embodiment; and

FIG. 7 illustrates an exemplary hardware device for interacting with a user in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Features of various embodiments of systems and methods described herein utilize a hybrid conversational architecture that can leverage multimodal data from various data sources. These include offline static, textual data as well as data from human interactions and dynamic data sources. The system can therefore learn in both offline and online fashion to perform both goal-driven and non-goal-driven tasks. Accordingly, systems and methods of various embodiments may have some pre-existing knowledge (learned from static knowledge sources) along with the ability to learn dynamically from human interactions in any conversational environment.

The system can additionally learn from continuous conversations between agents in a multi-agent framework. With this framework the agent can basically replicate itself to create multiple instances such that it can continuously improve on generating the best possible response in a given scenario by possibly mimicking an adversarial learning environment. This phenomenon can go on silently using the same proposed architecture when the system is not active (i.e., not involved in a running conversation with the user and/or before the deployment phase when it is going through rigorous training via static and dynamic learning to create task specific models).

The systems and methods of various embodiments described herein are far more versatile than the existing techniques discussed previously. The system described herein can learn from both static and dynamic sources while considering multimodal inputs to determine appropriate responses to user dialogues. The systems and methods of various embodiments described herein therefore provide a conversational companion agent to serve both task-driven and open-domain use cases in an intelligent manner.

The conversational agents described herein may prove useful for various types of users in various applications. For example, the conversational agents described herein may interact with the elderly, a group of people that often experience loneliness. An elderly person may seek attention from people such as their family, friends, and neighbors to share their knowledge, experiences, stories, or the like. These types of communicative exchanges can provide them comfort and happiness which can often lead to a prolonged and better life.

This is especially true for elderly people that are sick. These patients can, with the presence of family and friends, heal faster than they would otherwise. This phenomenon is supported by many studies that show a loved one's presence and support can significantly impact a patient's recovery efforts.

With the modern day lifestyle and busy schedules of many people, however, providing continuous, quality support is often difficult or impossible. For example, a patient's family member may have a demanding work schedule or live in location that makes frequent visits to the patient difficult.

The conversational agent(s) described herein can at least provide an additional support mechanism for the elderly in these scenarios. These agents can act as a friend or family member by patiently listening and conversing like a caring human. The agent can, for example, console a user at a moment of grief and sorrow by leveraging knowledge of personal information to provide personalized content. The agent can also shift conversational topics (e.g., using knowledge of the user's preferences) and incorporate humor into the conversation based on the user's personality profile (which is learned and updated overtime).

The agent can also recognize concepts of conversation that can be shared with family members and conversations that should be kept private. These private conversations may include things like secrets and personal information such as personal identification numbers and passwords. The agent may, for example, act in accordance with common sense knowledge based on training from knowledge sources to learn things that are customary to express and things that are not customary to express. Moreover, the agent has the ability to dynamically learn about user background, culture, and personal preferences based on real-time interactions. These conversations may be supplemented with available knowledge sources and to recognize context to assist in generating dialogue.

Additionally, systems and methods described herein may rely on one or more sensor devices to recognize and understand dialogue, acts, emotions, responses, or the like. This data may provide further insight as how the user may be feeling as well as their attitude towards the agent at a particular point in time.

The agent can also make recommendations for activities, restaurants, activities, travel, or the like. The agent may similarly motivate the user to follow healthy lifestyle choices as well as remind the user to, for example, take medications.

The overall user experience can be described as similar to meeting with a new person in which two people introduce each other and get along as time passes. As the agent is able to learn through user interactions, it ultimately transforms itself such that the user views the agent as a trustworthy companion.

The above discussion was largely directed to older users such as the elderly. However, embodiments described herein may also be used to converse with children. Children are curious by nature and tend to ask a lot of questions. This requires a significant amount of attention from parents, family members, and caregivers.

The proposed systems and methods described herein can be used to provide this required attention. For example, agents can understand and answer questions using simple analogies, examples, and concepts that children understand. In some embodiments, the agent(s) can engage a child in age-specific, intuitive games that can help develop the child's reasoning and cognitive capacities.

Similar to the functionality provided to adults, the agent(s) can encourage the children to eat healthy food and can educate them about healthy lifestyle habits. The agent(s) may also be configured to converse with the children using vocabulary and phrases appropriate to the child's age. To establish a level of trust with the child and to comfort the child, the agent may also be presented as a familiar cartoon character.

People who wish to have children, or those who are expecting a child, may use the proposed system to get parenting experience. The agent in this embodiment may be configured to have the knowledge and mannerisms of a baby, toddler, young child, etc. Accordingly, the agent configured as a young child may interact with the users to mimic the experience of raising a young child.

The above use cases are merely exemplary and it is contemplated that the systems and methods described herein may be customized to reflect a user's needs. The system may be configured to learn certain knowledge, perform reasoning tasks, and make inferences from available data sources. Thus, the proposed system can be customized to perform any goal-driven task to be used by any person, entity, or company.

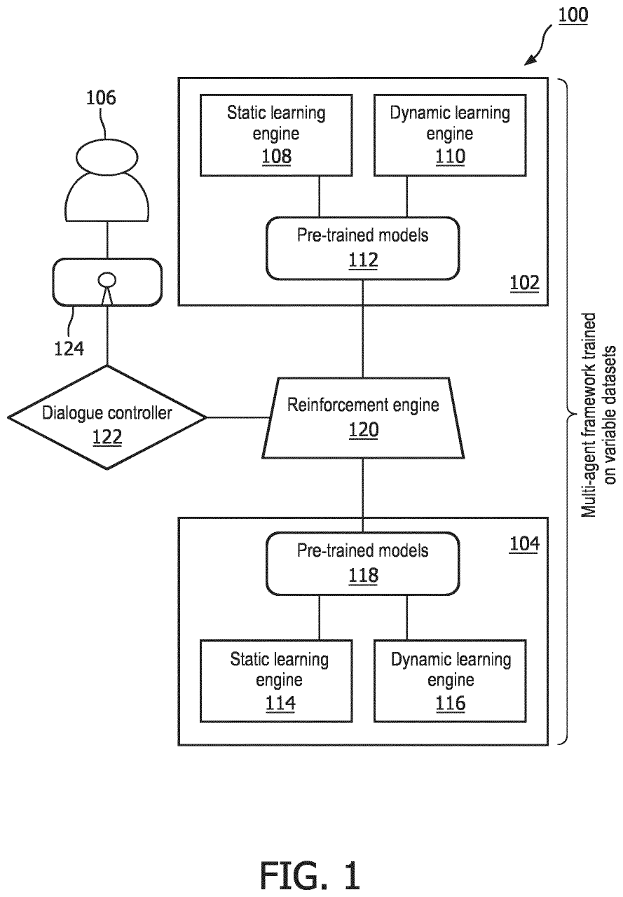

FIG. 1 depicts the high level architecture of a system 100 for interacting with a user in accordance with one embodiment. The system 100 may include multiple agents 102 and 104 (as well as others) used to provide dialogue to a user 106. The agent 102 may include a static learning engine 108, a dynamic learning engine 110, and a plurality of pre-trained models 112.

The multiple agent framework with agents 102 and 104 can function in an active mode or an inactive mode. While in the inactive mode (i.e. not involved in a running conversation with the user), the system can silently replicate itself to create multiple similar instances such that it can learn to improve through continuous conversations with itself in a multi-agent framework possibly by mimicking an adversarial learning environment.

The agent 104 may similarly include a static learning engine 112, a dynamic learning engine 116, and a plurality of pre-trained models 118. For the sake of simplicity, it may be assumed that agent 104 operates similarly to agent 102 such that a description of the agent 102 and the components therein may be applied to the agent 104 and the components therein. The agents 102 and 104 may be connected by a reinforcement engine 120 in communication with a dialogue controller 122 to provide content to the user 106. The system 100 may use an avatar agent 124 to deliver the content to the user 106 using an interface. This interface may be configured as any suitable device such as a PC, laptop, tablet, mobile device, tablet, smartwatch, or the like. Additionally or alternatively, the interface can be built as a novel conversational device (similar to an Alexa® device by Amazon, a Google Home® device, or similar device to meet the needs of various end users such as the elderly or children).

The reinforcement engine 120 may be implemented as any specially configured processor to consider the output of the components of the static and dynamic learning engines. The reinforcement engine 120 may be configured to weigh or otherwise analyze proposed outputs (e.g., based on associated rewards) to determine the most appropriate dialogue response to provide to the user 106.

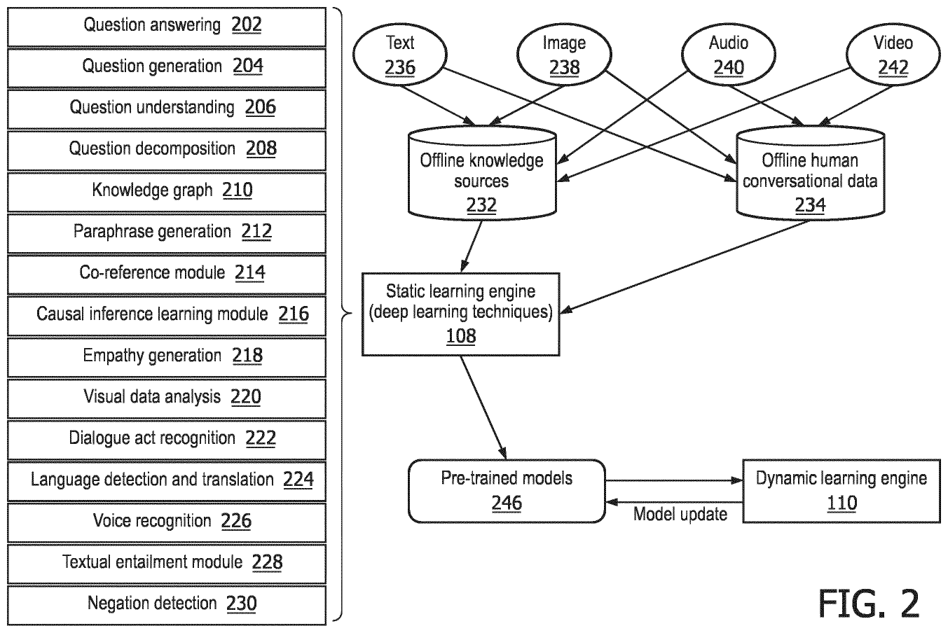

FIG. 2 illustrates the static learning engine 108 of FIG. 1 in more detail. As can be seen in FIG. 2, the static learning engine 108 includes a plurality of individual modules 202-230 that are each configured to provide some sort of input or otherwise perform some task to assist in generating dialogue for the user.

For example, the question answering module 202 may be configured to search available offline knowledge sources 232 and offline human conversational data 234 to come up with an answer in response to a received question.

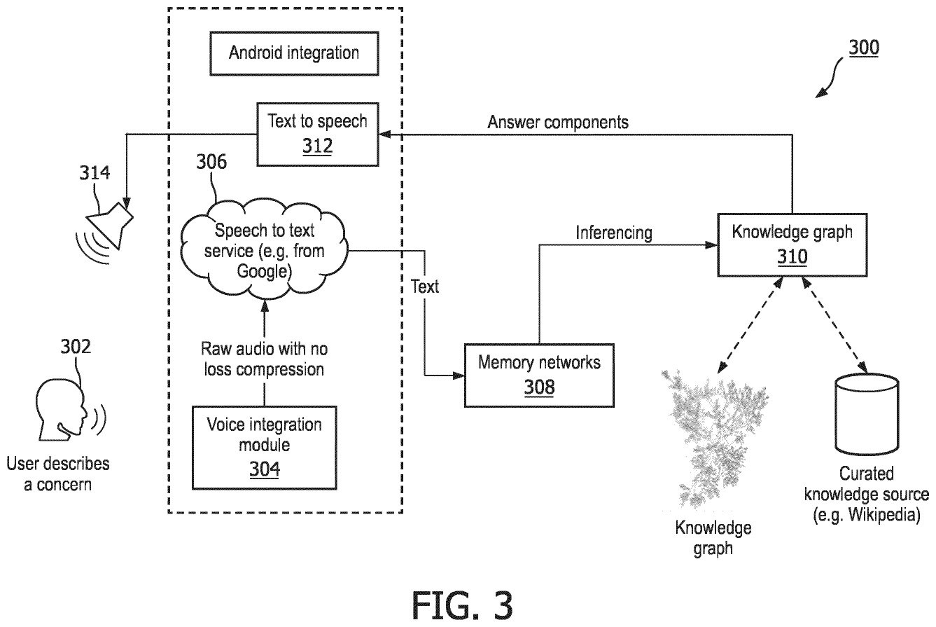

FIG. 3 illustrates the architecture 300 of the question answering module 202 of FIG. 2 in accordance with one embodiment. In operation, a user 302 may describe a concern or otherwise ask a question. The user 302 may ask this question by providing a verbal output to a microphone (not shown), for example. A voice integration module 304 may perform any required pre-processing steps such as integrating one or more sound files supplied by the user 302. The inputted sound files may be communicated to any suitable “speech-to-text” service 306 to convert the provided speech file(s) to a text file.

The text file may be communicated to memory networks 308 that make certain inferences with respect to the text file to determine the nature of the received question. One or more knowledge graphs 310 (produced by a knowledge graph module such as the knowledge graph module 210 of FIG. 2 discussed below) may then be traversed to determine appropriate answer components. These knowledge graphs 310 may be built from any suitable available knowledge source. The gathered data may be communicated to a text-to-speech module 312 to convert the answer components into actionable speech files. The agent may then present the answer to the user's question using a microphone device 314.

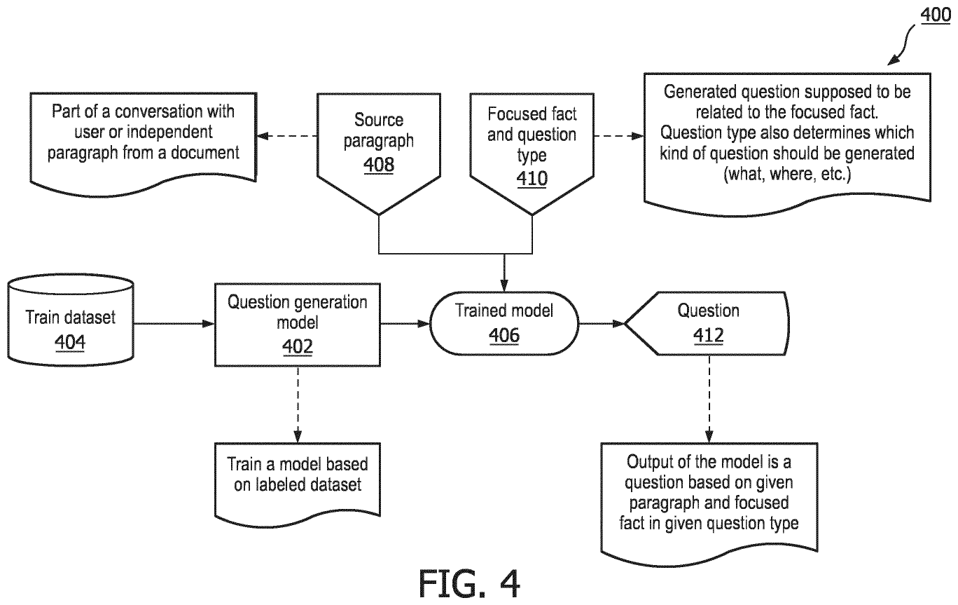

Referring back to FIG. 2, the question generation module 204 may be configured to generate dialogue questions to be presented to a user. FIG. 4 illustrates the architecture 400 of the question generation module 204 in accordance with one embodiment. The question generation model 402 may be trained on dataset 404 to generate a trained model 406. The trained model 406 may receive a source paragraph 408 that may include, for example, part of a conversation with a user or an independent paragraph from a document. Additionally or alternatively, the trained model 406 may receive a focused fact and/or question input 410. This input 410 may be a generated question supposed to be related to a focused fact. The “question type” refers to what kind of a question should be generated (e.g., a “what” question, a “where” question, etc.).

Referring back to FIG. 2, the question understanding module 206 may be trained in a supervised manner in which a large parallel corpus of questions, along with important question focus words, are identified. Given a question entered by a user, the question understanding module 206 may try to understand the main focus of the question by analyzing the most important components of the question via various techniques directed towards named entity recognition, word sense disambiguation, ontology-based analysis, and semantic role labeling. This understanding can then be leveraged to, in response, generate a better answer.

The question decomposition module 208 may transform a complex question into a series of simple questions that may be more easily addressed by the other modules. For example, a question such as “how was earthquake disaster in Japan?” may be transformed into a series of questions such as “which cities were damaged?” and “how many people died?” These transformations may help provide better generated answers.

The question decomposition module 208 may execute a supervised model trained on a parallel corpus of complex questions along with a set of simple questions using end-to-end memory networks with an external knowledge source. This may help the question decomposition module 208 to, for example, learn the association functions between complex questions and simple questions.

The knowledge graph module 210 may be built from a large structured and/or unstructured knowledge base to represent a set of topics, concepts, and/or entities as nodes. Accordingly, edges between these nodes represent the relationships between these topics, concepts, and/or entities.

As an example, the system 100 may be presented with a question such as “who is the prime minister of Canada?” In an effort to answer this question, the knowledge graph module 210 may traverse a knowledge graph to exploit various relationships among or otherwise between entities. The knowledge graph module 210 may leverage data from any suitable knowledge source.

The paraphrase generation module 212 may receive as input a statement, question, phrase, or sentence, and in response generate alternative paraphrase(s) that may have the same meaning but a different sequence of words or phrases. This paraphrasing may help keep track of all possible alternatives that can be made with respect to a certain statement or sentence. Accordingly, the agent will know about its policy and action regardless of which word or phrase is used to convey a particular message.

The paraphrase generation module 212 may also be built using a supervised machine learning approach. For example, an operator may input words or phrases that are similar in meaning. The model executed by the paraphrase generation module 212 may be trained from parallel paraphrasing corpora using residual long short-term memory networks (LSTMs).

The co-reference module 214 may be trained in a supervised manner to recognize the significance of a particular reference (e.g., a pronoun referring to an entity, an object, or a person). Therefore, the agent may understand a given task or question without any ambiguity by identifying all possible expressions that may refer to the same entity. Accordingly, the model executed by the co-reference module 214 may be trained with a labeled corpus related to an entity and possible expressions for the entity. For example, a text document may include different expressions that refer to the same entity.

The causal inference learning module 216 may be built from common sense knowledge along with domain-specific, structured and unstructured knowledge sources and domain-independent, structured and unstructured knowledge sources. These knowledge sources may represent the causal relationships among various entities, objects, and events.

For example, if it rains, the causal inference learning module 216 may tell the user to take an umbrella if they intend to go outside. This knowledge can be learned from a parallel cause and effect relationship corpus and/or from a large collection of general purpose rules.

The empathy generation module 218 may be trained to generate statements and/or descriptions that are empathetic in nature. This may be particularly important if a user is upset and seeking comfort during difficult times.

The model executed by the empathy generation module 218 may be trained using a supervised learning approach in which the model can learn to generate empathy-based text from a particular event description. The empathy generation module 218 may be trained similarly to the other modules using a parallel corpus of event descriptions and corresponding empathy text descriptions. Additionally or alternatively, a large set of rules and/or templates may be used for training.

The visual data analysis module 220 may implement a set of computer vision models such as image recognition, image classification, object detection, image segmentation, facial detection, and facial recognition models. The visual data analysis module 220 may be trained on a large set of labeled/unlabeled examples using supervised/unsupervised machine learning algorithms. Accordingly, the visual data analysis module 220 may detect or otherwise recognize visual objects, events, and expressions to help come up with an appropriate response at a particular moment.

The dialogue act recognition module 222 may recognize characteristics of dialogue acts in order to provide an appropriate response. For example, different categories speech may include greetings, questions, statements, requests, or the like. Knowledge of the inputted dialogue classification may be leveraged to develop a more appropriate response. The dialogue act recognition module 222 may be trained on a large collection of unlabeled and labeled examples using supervised or unsupervised learning techniques.

The language detection and translation module 224 may recognize and understand the language in which a conversation occurs. If necessary, the language detection and translation module 224 may switch to the appropriate language to converse with the user based on the user's profile, interests, or comfort zone.

The language detection and translation module 224 may also perform language translation tasks between languages if appropriate (e.g., if requested or required to converse with the user). The model executed by the language detection and translation module 224 may be trained to recognize the user's language from a large collection of language corpora using supervised/unsupervised learning. The model may be trained for language translation using encoder/decoder-based sequence-to-sequence architectures using corresponding parallel corpora (e.g., English-Spanish).

The voice recognition module 226 may recognize the voice of the user(s) based on various features such as speech modulation, pitch, tonal quality, personality profile, etc. The model executed by the voice recognition module 226 may be trained using an unsupervised classifier from a large number of sample speech data and conversational data collected from users.

The textual entailment module 228 may recognize if one statement is implied in another statement. For example, if one sentence is “food is a basic human need,” the textual entailment module 228 can imply that food is a basic need for the user too, and instruct the user to eat if they appear hungry.

The model executed by the textual entailment module 228 may be trained from a large parallel corpus of sentence pairs that include labels such as “positive entailment, “negative entailment,” and “neutral entailment.” The model may use deep neural networks for recognizing these textual entailments or generate alternative implications given a particular statement.

The negation detection module 230 may recognize negative implications in a statement, word, or phrase such that a more appropriate response can be generated. The model executed by the negation detection module 230 may rely on a negation dictionary, along with a large collection of grammar rules or conditions, to understand how to extract negation mentions from a statement.

The static learning engine 108 may execute the various modules 202-230 to provide responses using data from offline knowledge sources 232 and offline human conversational data 234. Data from these data sources 232 and 234 may include any combination of text 236, image, 238, audio 240, and video 242 data.

When offline or otherwise not in use, the static learning engine 108 may analyze previous interactions with a user to generate more appropriate responses for future interactions. For example, the static learning engine 108 may analyze a previous conversation with a user in which the user had said that their sister had passed away. In future conversations in which the user mentions they miss their sister, rather than suggesting something like “Why don't you give your sister a call?” the static learning engine 108 may instead suggest the user calls a different family member or change the topic of conversation. This reward-based reinforcement learning therefore leverages previous interactions with a user to continuously improve the provided dialogue and the interactions with the user.

The static learning engine 108 may execute the pre-trained models 236 of the modules 202-230 to develop an appropriate response. Output from the static learning engine 108 and, namely from the pre-trained models 246 may be communicated to the dynamic learning engine 110.

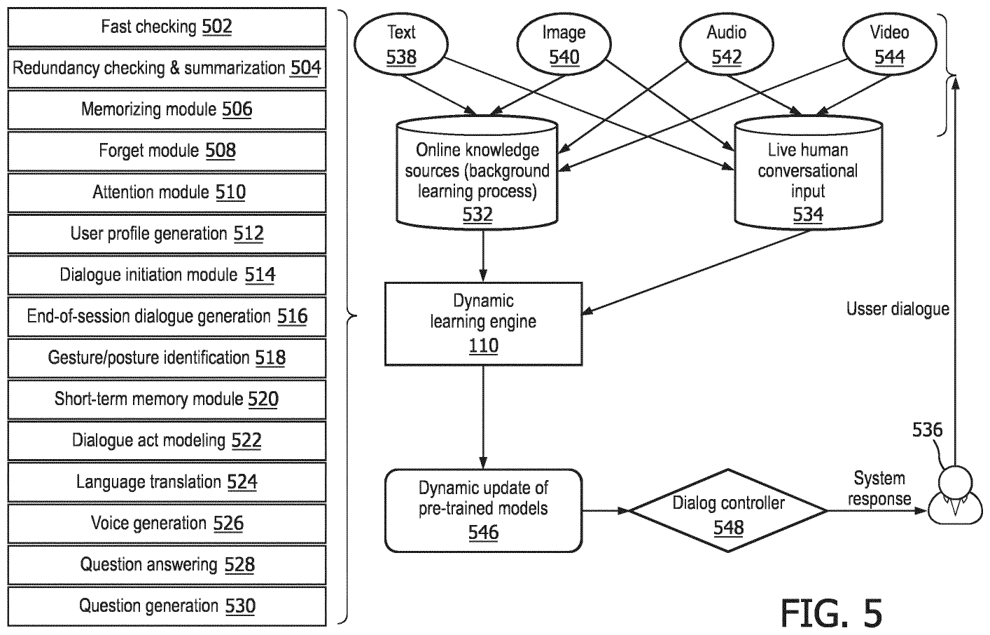

FIG. 5 illustrates the dynamic learning engine 110 of FIG. 1 in more detail. Similar to the static learning engine 108 of FIG. 2, the dynamic learning engine 110 may execute a plurality of modules 502-530 in generating a response to a user. The task of responding to a user is therefore split over multiple modules that are each configured to perform some task.

All modules 502-530 may be trained from large unlabeled or labeled data sets. These datasets may include data in the form of text, audio, video, etc. The modules 502-530 may be trained using advanced deep learning techniques such as, but not limited to, convolutional neural networks (CNNs), recurrent neural networks (RNNs), memory networks, or the like. The models of the various modules may be dynamically updated as new information becomes available online and/or via live human interaction using the deep reinforcement learning techniques.

The fact checking module 502 may determine whether a statement is factual or not by verifying it against a knowledge graph that is built in the static learning engine 108 (e.g., by the knowledge graph module 210) and also against any available online knowledge sources. These knowledge sources may include news sources as well as social media sources.

This fact-verification can be accomplished dynamically by leveraging content-oriented, vector-based semantic similarity matching techniques. Based on the verification (or failure to verify), an appropriate response can be conveyed to the user.

The redundancy checking and summarization module 504 may receive an input description and can dynamically verify if received content is redundant or repetitive within the current context (e.g., current within some brief period of time). This may ensure that content can be summarized to preserve the most important information to make it succinct for further processing into other modules of the framework.

The memorizing module 506 may receive the succinct content from the redundancy checking and summarization module 504. The memorizing module 506 may be configured to understand the content that needs to be memorized by using a large set of heuristics and rules. This information may be related to the user's current condition, upcoming event details, user interests, etc. The heuristics and rules may be learned automatically from previous conversations between the user and the agent.

The forget module 508 may be configured to determine what information is unnecessary based on common sense knowledge user profile interests, user instructions, or the like. Once this information is identified, the forget module 508 may delete or otherwise remove this information from memory. This improves computational efficiency. Moreover, the model executed by the forget module 508 may be dynamically trained over multiple conversations and through deep reinforcement learning with a reward-based policy learning methodology.

The attention module 510 may be configured to recognize the importance of certain events or situations and develop appropriate responses. The agent may make note of factors such as visual data analysis, the time of a conversation, the date of a conversation, or the like.

For example, the agent may recognize that at night time an elderly person may require an increased amount of attention. This additional level of attention may cause the agent to initiate a call to an emergency support system if, for example, the user makes a sudden, loud noise or makes other types of unusual actions.

The user profile generation module 512 may gather data regarding a user in real time and generate a user profile storing this information. This information may relate to the user's name, preferences, history, background, or the like. Upon receiving new updated information, the user profile generation module 512 may update the user's profile accordingly.

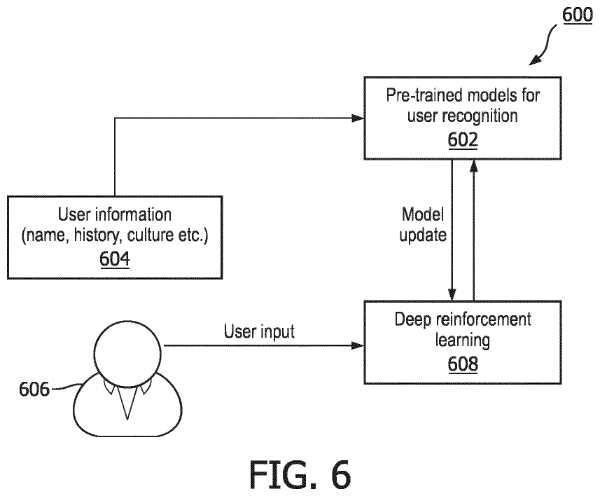

FIG. 6, for example, illustrates the workflow 600 of this dynamic updating process. FIG. 6 shows the pre-trained model(s) 602 executed by the user profile generation module 512 of FIG. 5. These models 602 may be trained on user information 604 such as the user's name, history, preferences, culture, or any other type of information that may enable the system 100 to provide meaningful dialogue to the user 606. Over the course of multiple interactions, the user 606 may provide additional input to a deep reinforcement learning algorithm 608. This user input may relate to or otherwise include more information, including changed or updated information, about the user and their preferences. This information may be communicated to the models 602 such that the models are updated to encompass this new user input.

Referring back to FIG. 5, the dialogue initiation module 514 may be configured to incrementally learn when to start or otherwise initiate a conversation with a user based on visual data and other user profile-based characteristics. This learning may occur incrementally over multiple conversations.

For example, the user may be uninterested in engaging in a conversation during certain times of the day such as during lunch or dinner. Once the dialogue initiation module 514 understands the current environment and the preferences of the user, it may generate a friendly dialogue or sentence for a potential start of a conversation at an appropriate time.

The end-of-session dialogue generation module 516 may be configured to understand when to end a conversation based on learned patterns or rules through datasets and through real-time user feedback. For example, the dialogue generation module 516 may learn to end a conversation at a particular time because they know the user likes to eat dinner at that time. Accordingly, the end-of-session dialogue generation module 516 may generate an appropriate dialogue to conclude a session at an appropriate time.

The gesture/posture identification module 518 may be configured to identify certain gestures and postures made by a user as well as their meanings. This learning may occur through visual analysis of the user's movements and motions to understand what type of response is expected in a particular environment and/or situation. With this understanding, the gesture/posture identification module 518 may generate appropriate dialogues in response to certain gestures or postures.

The short-term memory module 520 may be configured to learn which information in the current conversation context is important and remember it for a short, predetermined period of time. For example, if the current conversation is about one or more restaurants, the short-term memory module 520 may store the named restaurants or other locations for a short period of time such that it can preemptively load related background and updated information about them to resolve any possible queries from the user more quickly.

The dialogue act modeling module 522 may be configured to build upon the model built by the dialogue act recognition module 222 of the static learning engine 108 of FIG. 2. The dialogue act modeling module 522 may refine the model based on real-time user interaction and feedback during each conversation engine. The model may be updated using a deep reinforcement learning framework.

The language translation module 524 may build on its counterpart in the static learning engine 108 and refine the model through real-time user feedback using the deep reinforcement learning framework.

The voice generation module 526 can be configured to generate or mimic a popular voice through relevant visual analysis of the current situation. Before doing so, however, the voice generation module 526 may perform an initial check to determine whether it is appropriate or not to do so in the particular scenario. This may help the agent begin, end, and/or otherwise continue a conversation with a light and charming tone.

The model executed by the voice generation module 526 may be trained to leverage available voice sources from a large collection of audio files and video files. This additionally helps the agent understand word pronunciation and speaking styles to accomplish this task in real time.

The question answering module 528 may refine the model built by the question answering module 202 of the static learning engine 108 based on new and real-time information collected from online data and knowledge sources. Additionally, the model may be refined through real-time user interaction using the deep reinforcement learning framework.

The question generation module 530 may refine the model built by the question generation module 204 of the static learning engine 528. The refinement may be based on new information collected through real-time and continuous user feedback within the deep reinforcement learning framework.

All modules 502-530 may execute their respective models when appropriate based on data from online knowledge sources 532 and data from live human conversational input 534 from a user 536. Analyzed data from these sources may include text data 538, image data 540, audio data 542, video data 544, or some combination thereof.

The dynamic learning engine 110 may provide any appropriate updates for the pre-trained models 546 of the various modules 502-530. Again, these updates may be based on the data from the online knowledge sources 532 and live human conversational input 534.

Output from the various modules may be communicated to the dialogue controller 548 such as the dialogue controller 122 of FIG. 1. The dialogue controller 122 may then analyze the various outputs of the modules and select the most appropriate response to deliver to the user 536.

For example, the dialogue controller 122 may be implemented as a trained model that is configured with an interface with the user. Based on the dialogue received, the dialogue controller 122 may select one or more of a collection of models to activate with the input dialogue. These models may then provide output in response or may activate additional models. For example, the question understanding modules may receive a question and activate the knowledge graph module 210 with appropriate inputs to search for an answer. The answer may then be provided to the question answering modules to generate the answer.

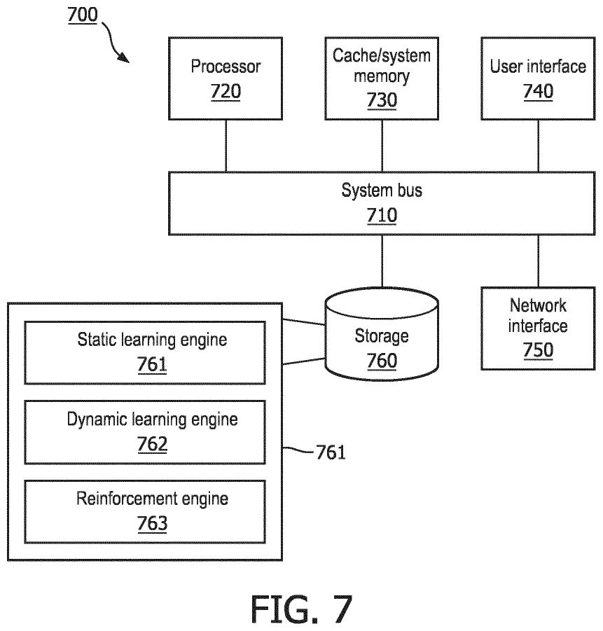

FIG. 7 illustrates an exemplary hardware device 700 for interacting with a user in accordance with one embodiment. As shown, the device 700 includes a processor 720, memory 730, user interface 740, network interface 750, and storage 760 interconnected via one or more system buses 710. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760 or otherwise capable of processing data. As such, the processor 720 may include a microprocessor, field programmable gate array (FPGA), application-specific integrated circuit (ASIC), or other similar devices.

The memory 730 may include various memories such as, for example L1, L2, or L3 cache or system memory. As such, the memory 730 may include static random access memory (SRAM), dynamic RAM (DRAM), flash memory, read only memory (ROM), or other similar memory devices.

The user interface 740 may include one or more devices for enabling communication with a user. For example, the user interface 740 may include a display, a mouse, and a keyboard for receiving user commands. In some embodiments, the user interface 740 may include a command line interface or graphical user interface that may be presented to a remote terminal via the network interface 750.

The network interface 750 may include one or more devices for enabling communication with other hardware devices. For example, the network interface 750 may include a network interface card (NIC) configured to communicate according to the Ethernet protocol. Additionally, the network interface 750 may implement a TCP/IP stack for communication according to the TCP/IP protocols. Various alternative or additional hardware or configurations for the network interface 750 will be apparent.

The storage 760 may include one or more machine-readable storage media such as read-only memory (ROM), random-access memory (RAM), magnetic disk storage media, optical storage media, flash-memory devices, or similar storage media. In various embodiments, the storage 760 may store instructions for execution by the processor 720 or data upon with the processor 720 may operate.

For example, the storage 760 may include an operating system 761 that includes a static learning engine 761, a dynamic learning engine 762, and a reinforcement engine 763. The static learning engine 761 may be similar in configuration to the static learning engine 108 of FIG. 2 and the dynamic learning engine 762 may be similar in configuration to the dynamic learning engine 110 of FIG. 5. The reinforcement engine 763 may be similar in configuration to the reinforcement engine 120 of FIG. 1 and may be configured to analyze the output from the static learning engine 761 and the dynamic learning engine 762 to select an appropriate communication for the user based on the output

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

1. A system for interacting with a user, the system comprising:
an interface for receiving input from a user;
a static learning engine having a plurality of static learning modules, each module preconfigured using at least one static knowledge source, wherein the static learning engine executes the plurality of static learning modules for generating a communication to the user;
a dynamic learning engine having a plurality of dynamic learning modules, each module trained in real time from at least one of the user input and at least one dynamic knowledge source, wherein the dynamic learning engine executes the plurality of dynamic learning modules for generating the communication to the user; and
a reinforcement engine configured to analyze output from at least one of the plurality of static learning modules and the plurality of dynamic learning modules, and further configured to select communication for the user based on the output from at least one of the plurality of static learning modules and the plurality of dynamic learning modules.
wherein the plurality of dynamic learning modules and the plurality of static learning modules are configured such that an output of one module activates another module.

2. The system of claim 1, wherein the at least one static knowledge source includes a conversational database storing data regarding previous conversations between the system and the user.

3. The system of claim 1, wherein at least one of the static knowledge source and the dynamic knowledge source comprises text, image, audio, and video.

4. The system of claim 1 further comprising an avatar agent transmitting the selected communication to the user via the interface.

5. The system of claim 1, wherein the input from the user includes at least one of a verbal communication, a gesture, a facial expression, and a written message.

6. The system of claim 1, wherein the reinforcement engine associates the output from at least one of the plurality of static learning modules and the plurality of dynamic learning modules with a reward, and selects the communication based on the reward associated with a particular output.

7. The system of claim 1, wherein each of the plurality of static learning modules and the plurality of dynamic learning modules is configured to perform a specific task for generating the communication to the user.

8. The system of claim 1, further comprising a plurality of dynamic learning modules and a plurality of static learning modules that together execute a plurality of models that are each specially configured to perform a certain task to generate a response to the user.

9. (canceled)

10. A method for interacting with a user, the method comprising:
receiving input from a user via an interface;
executing, via a static learning engine having a plurality of static learning modules, each module preconfigured using at least one static knowledge source, the plurality of static learning modules for generating a communication to the user;
executing, via a dynamic learning engine having a plurality of dynamic learning modules, each module trained in real time from at least one of the user input and at least one dynamic knowledge source, the plurality of dynamic learning modules for generating the communication to the user;
analyzing, via a reinforcement engine, output from at least one of the plurality of static learning modules and the plurality of dynamic learning modules; and
selecting, via the reinforcement engine, communication for the user based on the output from at least one of the plurality of static learning modules and the plurality of dynamic learning modules.
wherein the plurality of dynamic learning modules and the plurality of static learning modules are configured such that an output of one module activates another module.

11. The method of claim 10, wherein the at least one static knowledge source includes a conversational database storing data regarding previous conversations between the system and the user.

12. The method of claim 10, wherein at least one of the static knowledge source and the dynamic knowledge source comprises text, image, audio, and video.

13. The method of claim 10, further comprising transmitting the selected communication to the user through the interface via an avatar agent.

14. (canceled)

15. The method of claim 10, further comprising associating the output from at least one of the plurality of static learning modules and the plurality of dynamic learning modules with a reward using the reinforcement engine, and selecting the communication using the reinforcement engine based on the reward associated with a particular output.

16. The method of claim 10, wherein each of the plurality of static learning modules and the plurality of dynamic learning modules is configured to perform a specific task to assist in generating the communication to the user.

17. A computer readable medium containing computer-executable instructions for interacting with a user, the medium comprising:
computer-executable instructions for receiving input from a user via an interface;
computer-executable instructions for executing, via a static learning engine having a plurality of static learning modules, each module preconfigured using at least one static knowledge source, the plurality of static learning modules for generating a communication to the user;
computer-executable instructions for executing, via a dynamic learning engine having a plurality of dynamic learning modules, each module trained in real time from at least one of the user input and at least one dynamic knowledge source, the plurality of dynamic learning modules for generating the communication to the user;
computer-executable instructions for analyzing, via a reinforcement engine, output from at least one of the plurality of static learning modules and the plurality of dynamic learning modules; and
computer-executable instructions for selecting, via the reinforcement engine, communication for the user based on the output from at least one of the plurality of static learning modules and the plurality of dynamic learning modules.
wherein the plurality of dynamic learning modules and the plurality of static learning modules are configured such that an output of one module activates another module.
